(19) United States
(12) Patent Application Publication
(10) Pub. No.: US 2023/0394393 A1
(43) Pub. Date: Dec. 7, 2023

(54) System and Methods for Quickly Identifying an Individual's Knowledge Base and Skill Set

(71) Applicant: 4D Technologies, LLC, Bedford, NH (US)

(72) Inventors: James Hancock, West Chesterfield, NH (US); David Micciche, Bedford, NH (US)

(73) Assignee: 4D Technologies, LLC, Bedford, NH (US)

(21) Appl. No.: 18/236,800

(22) Filed: Aug. 22, 2023

Related U.S. Application Data
(63) Continuation-in-part of application No. 17/716,038, filed on Apr. 8, 2022, now abandoned.
(60) Provisional application No. 63/172,242, filed on Apr. 8, 2021.

(51) Int. Cl. G06Q 10/0631; G06Q 10/1053; G06Q 50/20

(52) U.S. Cl. CPC G06Q 10/063112; G06Q 10/1053; G06Q 50/2057

(57) ABSTRACT

A system and methodology for determining the frontal edge of knowledge of an individual in an efficient manner using a hierarchal knowledge data structure is provided. The process (implemented by the system and/or methods) include navigating the branches of the hierarchal knowledge data structure in a statistically efficient manner to assess or determine the knowledge status and skill set of each concept, and wherein less than all the concepts are tested in the hierarchal knowledge data structure.

### CROSS-REFERENCE TO RELATED APPLICATIONS

This matter is a continuation-in-part and claims priority to U.S. patent application Ser. No. 17/716,038, filed Apr. 8, 2022, entitled “System and Methods for Quickly Identifying an Individual's Knowledge Base and Skillset,” which application claims priority to U.S. Provisional Patent Application No. 63/172,242, filed Apr. 8, 2021, each of which are incorporated herein by reference.

### BACKGROUND OF THE INVENTION

This disclosure relates to methods and systems for quickly identifying an individual's knowledge base and skillsets within a software platform.

Identifying the skill level and knowledge of a given individual can be an expensive and timely venture, often involving experts and knowledge tests that have a robust understanding of some topic. For the person being evaluated, knowledge tests can take a considerable amount of time to complete. Training programs and/or temporary or probationary periods take a significant amount of time and are expensive if the end goal is determining the knowledge base and skill set of a given individual.

Aspects of the disclosed subject matter set forth systems and methods that expedite the process of determining an individual's knowledge and skill set by generating specific tests with respect to desired objectives and/or concepts, and specifically identify the frontal edge of knowledge for a given user with respect to the desired objective and/or concepts. Further, numerous advantages of the disclosed subject matter will become apparent to those skilled in the art through the detailed description and drawings set forth below.

### SUMMARY OF THE INVENTION

According to aspects of the disclosed subject matter, systems and methods for quickly identifying an individual's knowledge base and skill set within a software platform are presented. For identifying the individual's knowledge base and skill set, a knowledge data structure is accessed. This knowledge data structure is a hierarchically arranged structure of concepts, with concepts at a higher level corresponding to a higher level of knowledge and/or skill, connected to concepts at a next-lower level corresponding to a lesser level of knowledge but knowledge that is requisite to understand the concept at the higher level. Additionally, and according to aspects of the disclosed subject matter, the identification or assessment of an individual's knowledge base and/or skill set is determined relative to a desired objective. To assess or identify an individual's knowledge and/or skill set, a desired objective, i.e., a collection of one or more concepts within the knowledge data structure, is identified. This desired objective corresponds to the “ideal” or highest level of knowledge that is sought, relative to the objective. A floor objective may be optionally identified to establish a lowest level of knowledge and/or skill set that will be utilized in determining the knowledge and skill set of the tested individual. In aspects of the disclosed subject matter, the hierarchy data structure (or, more simply, the hierarchy) between the desired objective and the floor is divided into quintiles. Thereafter, as part of maximizing the evaluation process, the selection of concepts for querying the individual with concepts within the fourth highest quartile. Advantageously, by beginning near the top, i.e., in the fourth highest quartile, those individuals that are most qualified are advantaged, identifying a substantial amount of skill without interacting with the process at numerous lower-level concepts and the corresponding knowledge, and/or skill of those lower-level concepts. Alternatively and advantageously, those will knowledge and/or skill that does not meet the information at the fourth quartile need only process one or two queriers at that level before being queried over concepts at a lower level. In short, the overall efficiency of the process is enhanced irrespective of the knowledge of a given individual being assessed. Additionally, for those that respond correctly at a particular level (either over a single query or multiple queries of the same quartile), the process then advances to concepts of the next higher quartile. Alternatively, for those individuals that respond incorrectly at a particular level, the process switches to targeting concepts of a quartile 2 levels lower (or one or no levels, dependent on whether they had been lowered to concepts of either the first or second quartiles.) During the course of processing, the frontal level of knowledge for the individual is determined according to correct responses to the queries that take place.

According to additional aspects of the disclosed subject matter, methods and systems for determining a training program for an individual are presented. Indeed, based on the determination of the frontal knowledge of an individual's knowledge base and skill set with respect to a desired objective, an evaluation may determine the concepts are still lacking in the knowledge base/skill set of the individual with respect to the desired objective. Rather than prescribing course learning for the individual, where each course includes multiple concepts including at least one concept that is lacking, the process determines the concepts and prerequisite concepts down the hierarchy to the frontal knowledge of the individual. A learning program is then devised that brings the individual from his/her front knowledge to the desired objective based on and including only those concepts in the hierarchy of concepts that will bring the individual's frontal knowledge to the level of the desire objects. Further still, an estimate may be made with respect to the amount of time that the individual may need to elevate (through the specific training) his/her frontal knowledge to the desired objective. This objective may be based on the averages of others and/or through the application of a trained machine learning model specifically trained to predict a likely training time for the individual.

According to aspects of the disclosed subject matter, evaluations and ordering among various individuals with respect to their frontal knowledge (relative to a desired objective) may be made. This evaluation may include converting the frontal knowledge to a multi-dimensional vector (each dimension corresponding to one of the concepts at the top-most level of the desired objective) and evaluating each individual's front knowledge proximity to the desired objecting in the multi-dimensional space. Operations utilizing dot-product differences may be used to identify a proximity distance of an individual to the desired objective. Furthermore, this measurement between individuals may be made according to a trained machine learning model. Advantageously, a machine learning model may be trained to determine the evaluations not only on the apparent proximity distance between an individual's front knowledge and the desired objective, but also based on a machine-learned evaluation of the difficulty in navigating the distance from an individual's current projection in the multi-dimensional space and the desired objective, as well as the time predicted to navigate that distance.

According to further embodiments of the disclosed subject matter, an automatic assessment generator and updating assessment method are presented. In execution by the assessment generator, the assessment method comprises the steps of receiving a desired objective for evaluating an individual's knowledge base and skill set. Based on the desire object, a query is made to a knowledge data structure to determine a set of one or more concepts associated with that desired objective. A subsection of the hierarchal data structure is identified, this subsection corresponding to concepts to the knowledge and skill set of the desire objective. The subsection of the hierarchal data structure (or, for readability, the knowledge subsection) is parsed into sections. According to aspects of the disclosed subject matter, a question is associated with each concept of each section, and each concept is connected in a hierarchical structure to one or more concepts in another section above or below a current section. A starting section is determined based on a user's history and an iterative process is begun, assessing a first question associated with a randomly selected concept within the starting section. Based on whether the individual demonstrates that he/she has/does not have the knowledge or skill set of that concept, a determination is made as to a next section to assess as part of the iterative process. In various embodiments, if the individual's response to the query regarding a concept is correct, the assessment iteration moves to a next higher section in the knowledge subsection. Alternatively, if the individual's response to the query regarding a concept is incorrect, the assessment iteration moves down two sections in the knowledge subsection to continue the assessment.

### BRIEF DESCRIPTION OF DRAWINGS

The foregoing aspects and many of the attendant advantages of the disclosed subject matter will become more readily appreciated as they are better understood by reference to the following description when taken in conjunction with the following drawings, wherein:

FIG. 1 illustrates a flowchart of the taxonomy for generating a knowledge (and/or skill-based) data structure for use in assessing an individual, according to aspects of the disclosed subject matter;

FIG. 2 illustrates an example knowledge data structure, according to aspects of the disclosed subject matter;

FIGS. 3A-B illustrate testing methodologies for using a generated knowledge data structure, according to aspects of the disclosed subject matter;

FIGS. 4A-C illustrate a visual interpretation of an individual navigating the testing methodology using a generated knowledge data structure and in accordance with aspects of the disclosed subject matter;

FIG. 5 illustrates the speed at which a user could navigate a knowledge data structure, which is contrasted to that of FIG. 4C, in accordance with aspects of the disclosed subject matter;

FIGS. 6A-B illustrate Match Scores upon completing an assessment on a knowledge data structure, in accordance with aspects of the disclosed subject matter;

FIG. 7 illustrates a flowchart for using a knowledge data structure to reinforce knowledge into long term memory, in accordance with aspects of the disclosed subject matter;

FIG. 8 illustrates a basic computing system that can operate the methods and processes described herein, in accordance with aspects of the disclosed subject matter;

FIG. 9 illustrates a method of assessing an individual's knowledge and/or skill set with respect to a desired objective, in accordance with aspects of the disclosed subject matter;

FIG. 10 illustrates a method for quantifying an individual's frontal knowledge into a normalized, scaled, multi-dimensional vector, in accordance with aspects of the disclosed subject matter; and

FIG. 11 illustrates a logical organization of computer-readable media bearing executable components that, when executed on a computer system, implement an assessment in accordance with aspects of the disclosed subject matter

### DETAILED DESCRIPTION OF THE INVENTION

As noted above, one of the objectives of the embodiments and description presented herein is to expedite an assessment process of individuals with respect to their knowledge and/or skill set of a desired objective. Another objective is to identify the frontal edge of an individual's knowledge base or skill sets.

Presented herein are methodologies to generate a knowledge data structure, which can be used as part of an assessment process of individuals. Additionally, methodologies of navigating the knowledge data structure in an efficient and effective manner are presented so as to reduce overall testing and assessment time of individuals while identifying an accurate knowledge or skill baseline, i.e., the frontal knowledge of the individual.

For purpose of this description when referring to a knowledge data structure, the terms knowledge and skill can be used interchangeably, as they simply denote the type of concepts in a given knowledge data structure, i.e., knowledge concepts or skill concepts. Both can be assessed. Other types of concepts can also be assessed, and thus could also be interchanged and are considered within the scope of this description. Generally speaking, knowledge refers to an understanding of principles or information, whereas skills generally refer to performance of tasks.

These methodologies have a wide array of applications. Some of these include assessments for students, assessments of employees, and/or assessments of potential employment candidates. One advantage of the systems and methods described herein includes filtering out initial candidates for a job based on knowledge and skills prior to assessing other criteria, such as corporate fit. Advantageously, this assessment may be done in a completely anonymous manner, thus reducing any preconceived prejudices and/or biases, whether real or perceived, from entering into a hiring process, which could be a result of gender, race, religion, sexuality, age, and any other category that is viewed as potentially discriminatory.

The identification of a true “frontal edge” knowledge/skill assessment enables the tailoring of efficient education and training programs for individuals. Efficient in that unnecessary redundancy is eliminated and specific concepts can be targeted accurately.

For purposes of this disclosure, the term concept means an item of knowledge or a skill which is represented within a knowledge data structure.

For purposes of this disclosure, the term node (in reference to nodes in a hierarchical knowledge data structure) is a concept that can be connected to another concept by a single knowledge relationship. A node/concept can be connected to multiple nodes/concepts.

For purposes of this disclosure, the term objective corresponds to a set of concepts within a hierarchical knowledge data structure and correspond to a level of knowledge and skill. A desired concept is a set of concepts that corresponds to a desired level of knowledge and/or skill set. An objective does not include multiple concepts in the same branch in the hierarchical knowledge data structure.

For purposes of these embodiments, the term knowledge relationships refers to the path formed by a plurality of relationships that connect concepts within the knowledge data structure.

For purposes of these embodiments, the term nexus concept refers to concepts that have a disproportionate number of dependencies (lower-level concepts) above the average number of dependencies.

For purposes of these embodiments, the term section(s) means a row applied to a section of a hierarchical knowledge data structure.

For purposes of these embodiments, the term statistical quintile or, more simply, ‘quintile’ refers to a section of a subsection of a hierarchal knowledge data structure that has been sectioned into five groups. It should be understood that a given quintile could have one or more rows within it. For example, a hierarchal tree that has 15 sections, could have 3 rows per each quintile. There are statistical advantages of navigating the hierarchal tree based on quintile groupings and moving up or down a specified number of quintiles given a correct or incorrect answer. It is understood there may be other efficient groupings, e.g., dividing the subsection of the knowledge data structure into septile (7) groups, but the preferred embodiments utilize quintile groupings.

A hierarchal tree can include one or more branches. Branches can span more than one row or section.

Additional terminology includes ‘not known,’ ‘inferred known,’ ‘tested known,’ and ‘tested not-known.’ NOT KNOWN generally refers to a node representative of a concept where an underlying dependent concept was previously tested not known or incorrect. The inference is that if a test taker/individual doesn't understand an underlying concept, then they likely do not understand how to answer correctly a question associated with a concept that depends upon that underlying concept, thus in the interest of efficiency there is no need to test that particular node, which it is then given the status ‘not known’.

Tested known or tested not-known refer to concepts where the test taker or user has taken a question associated with that concept and either gotten the answer correct (tested known) or gotten the answer incorrect (tested not-known). Finally, ‘inferred known’ refers to a concept that has not been tested on, but where the user has ‘tested known’ to a concept that depends upon the ‘inferred known’ concept. The rationale here is if a user can adequately navigate a higher-level concept, it is inferred that they also understand the underlying concepts upon which that higher level concept depends, thus there is no need to test on it, which again contributes to efficiently navigating a hierarchal tree. It will be described further below, but in the associated figures, ‘inferred known’ status is usually represented by the term KNOWN, whereas tested known and tested known are represented by check marks and X-marks respectively.

The term ‘pending’ is an indicator (or could simply be blank) for each node that has not been tested and has not had its status determined to be ‘not known’ or ‘inferred known,’ which as noted above are based on the dependency relationship between those nodes that have been tested known or tested not-known.

Those in the field of game design will understand Z-order and perspective lines. Most of the literature on this subject is with regards to finding the perspective lines when the Z-order is known. For this application, the opposite approach is occurring, where the effective perspective lines or rather relationships between nodes are known, but the Z-order is what is being discovered and determined. The system and methods described herein not only help accomplish this but do so in an efficient manner.

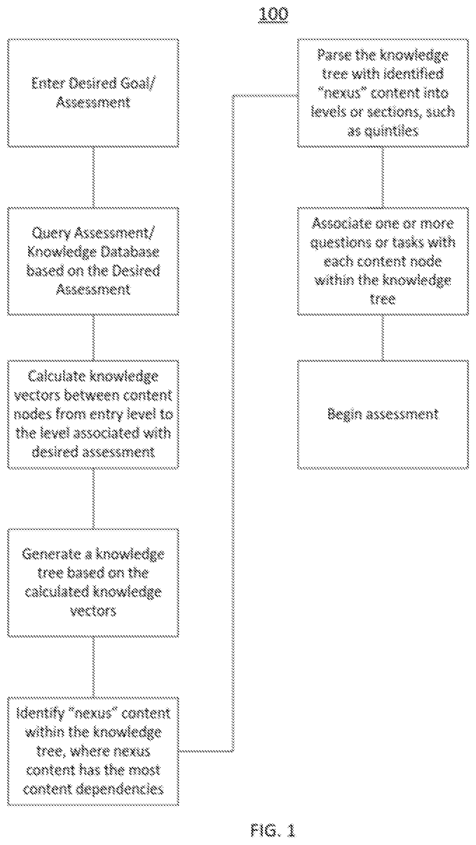

It is important to have or establish a hierarchal knowledge data structure, so that it can be navigated in an efficient manner. Turning to FIG. 1, this figure illustrates a flowchart 100 of the taxonomy for generating a hierarchal knowledge data structure for use in assessing an individual's knowledge or skill set in an efficient manner. A computing system 800 is described further below for implementing this process, but referring to the flowchart 100 of FIG. 1, a desired objective corresponding to an assessment level can be entered into the computing system. This input can cause a processor to query a knowledge data structure so as to begin identifying knowledge concepts associated with the desired objective and parsing the concepts into various nodes. Each node can include one or more connectors connecting the node(s) to other nodes within the hierarchical knowledge data structure. The connections can be in the form of a relationship, such as a dependency or component relationship. The processor of the computing system can then begin to calculate knowledge vectors, which begins sorting the nodes into a hierarchal form. For example, if the desired objective is a particular level of algebra that solves for a missing variable, then that concept would be linked to multiple other concepts, such as addition, subtraction, multiplication, division, fractions, decimals, order of operations and so forth. Although there is a connection between addition and solving for a missing variable, there are other concepts, such as order of operations that build on addition, subtraction, multiplication, and division, to enable solving for a missing variable, thus the computing system can sort those connections into knowledge vectors to organize these relationships. In an alternative embodiment, these connections may already be encoded into the knowledge data structure. Once these connections/relationships are organized, they can be sorted to identify ‘nexus’ concepts represented by ‘nexus’ nodes that act as an efficient bridge between the various concepts of the desired objective. By using these ‘nexus’ nodes, and particularly those with the most dependencies, an efficient knowledge data structure corresponding to the desired objective can be organized. This knowledge data structure can be subdivided into various sections, which include the concepts (represented as nodes on top of the structure) that represent the knowledge needed to achieve the desired objective or assessment level and all the dependent nodes sorted into sections down to what might be considered a base or entry level. As noted above and according to aspects and embodiments of the disclosed subject matter, these sections may be divided into quintiles for more efficient processing in the evaluation of an individual.

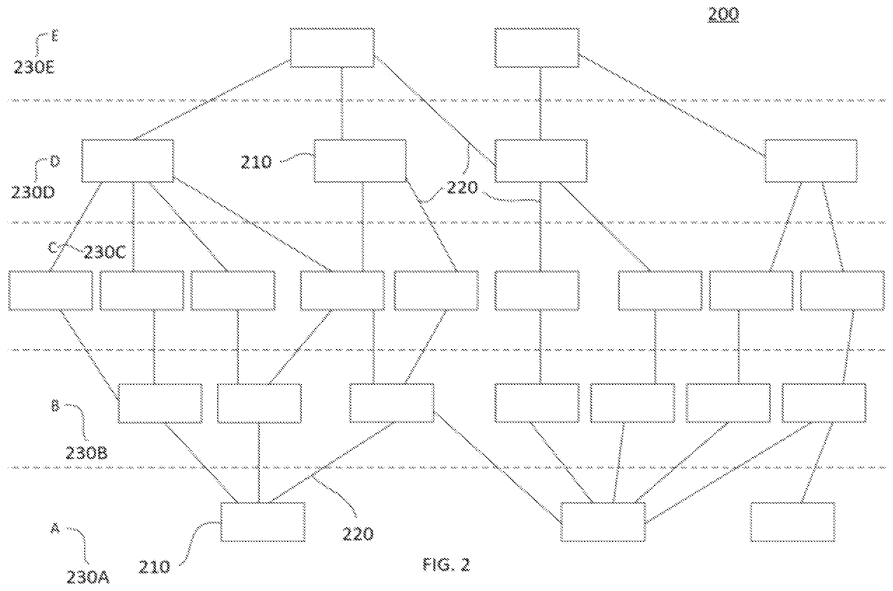

FIG. 2 illustrates an example hierarchal knowledge data structure 200. As noted above, this structure 200 comprises a plurality of nodes 210 that each represent a particular concept. Those nodes 210 each have at least connection 220 that forms a relationship between the nodes. Some nodes/concepts can have multiple connections with multiple nodes. Continuing the above example, the concept of subtraction can be linked to both division as well as fractions. With respect to the hierarchical knowledge data structure 200, it can be parsed into sections, such as sections 230A-E. In this use-case, five (5) sections or quintiles were chosen. It should be understood that sections are in part defined by the number of relationships above and below a particular node. The nodes of each section may or may not be the same difficulty level, thus the term section is being used as opposed to the term knowledge level or just level, which is often associated with difficulty. However, whether sections 230A-E are defined as sections or levels, the sectioning is carried out to navigate each section in an efficient manner, and to enhance efficiency in assessing an individual's knowledge and skill set.

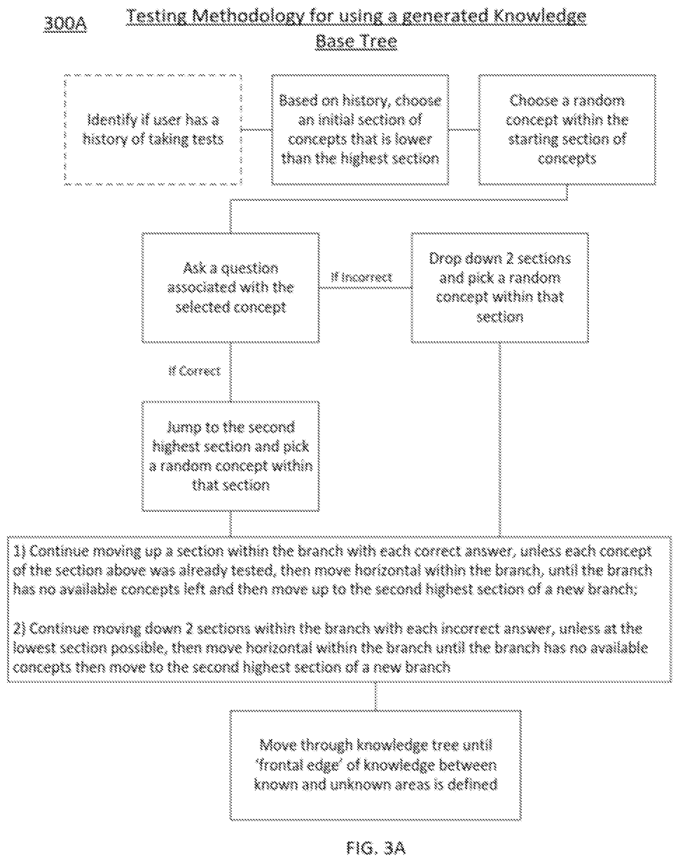

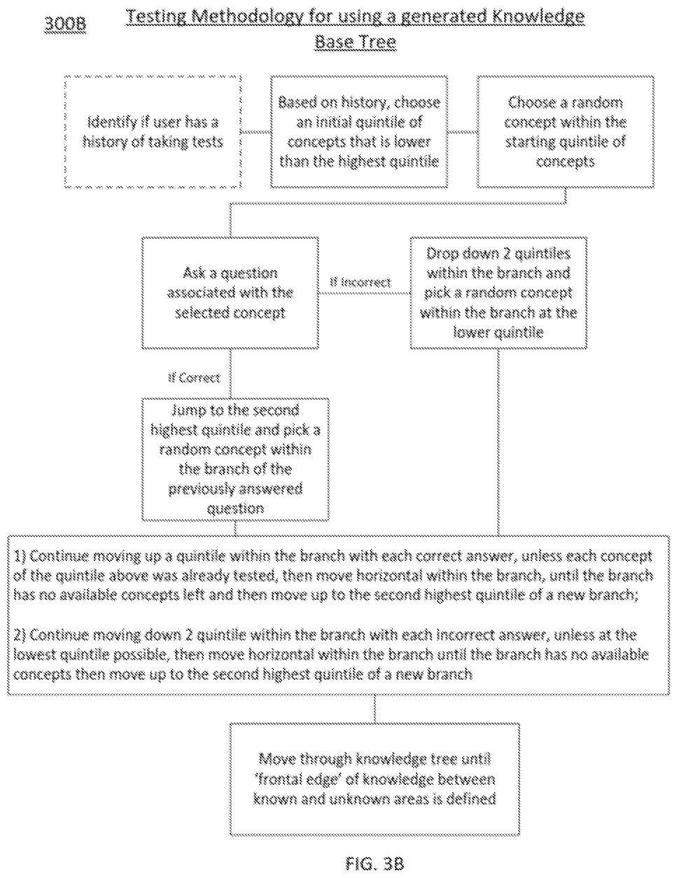

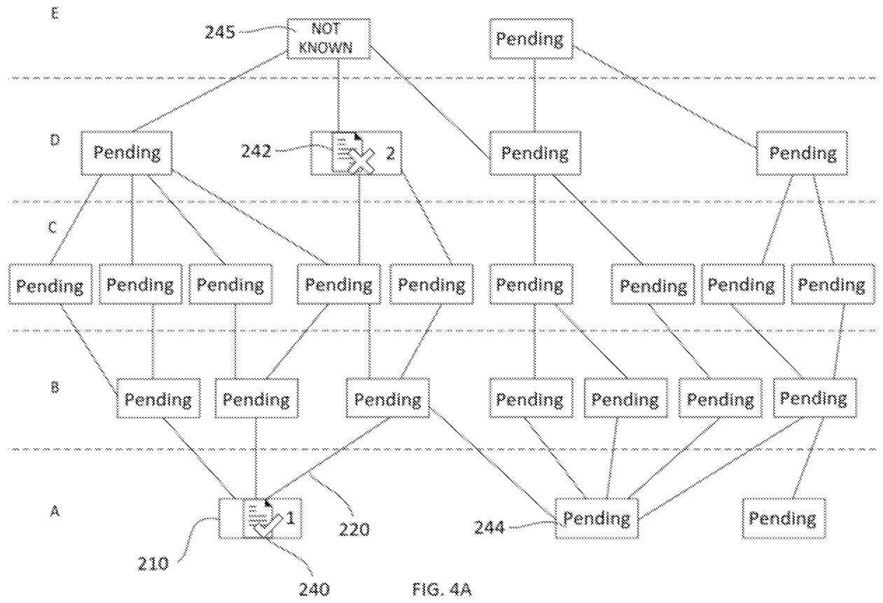

Regarding navigating a hierarchal data structure 200, or some subsection of a hierarchical data structure, FIGS. 3A-B illustrate efficient testing methodology flowcharts 300A and 300B. One of the main distinctions between 300A and 300B, is that 300A refers to the use of sections, whereas 300B refers to the use of quintiles. Both are being used to convey the efficiency of navigating a hierarchal data structure (or some subsection of the structure). According to this method, one of the first tasks is to determine where to start or rather which section/quintile to start assessing the individual in. In one embodiment, the process starts every individual for assessment at the second to lowest section/quintile, with the notion that the lower sections/quintiles tend to have concepts that are more foundational in nature as opposed to the concepts in the higher sections/quintiles. For an individual that has no testing history or poor testing history, starting in a section/quintile, such as the second one up from the bottom, e.g., section 230B in FIG. 2, might allow the individual being assessed to start the assessment on a positive note. Alternatively, in other embodiments a system/process might be configured to start the assessment in section/quintile 230A for the same positive start reasons. Alternatively, if the individual being assessed does have positive testing history, a higher section/quintile might be more appropriate to expedite the assessment faster, as will be apparent through the next steps in flowcharts 300A and 300B.

Once a starting section/quintile has been selected, the system/method, can then randomly select a concept in that given section/quintile associated with a particular branch (corresponding to one or more concepts of a desired objective) of the hierarchal data structure. Again, if the starting section/quintile were section/quintile 230B, any one of the 7 concepts in that section could be selected. Once a concept, as represented by a node, is selected any question or skill associated with that concept can then be given to the user to begin assessing their knowledge or skill set based on the desired objective. If the user answers a question or generates an acceptable response for a skill assessment associated with the concept, the process can then advance the user to a higher section/quintile up the particular branch, randomly select (if possible) one of the concepts in that higher section/quintile within that branch and present a question or skill assessment associated with that concept.

If the individual, during assessment, incorrectly answers a question, then the process can “drop” the individual down two (2) sections/quintiles within that branch. Of course, if dropping down two (2) sections is not possible, the process utilizes concepts/nodes one a section/quintile that is one lower. Even further, if it is not possible (i.e., there are no more lower sections) then the individual remains in the lowest section/quintile and move horizontally within that section or, alternatively, is switched to another branch in the lowest section/quintile for further assessment.

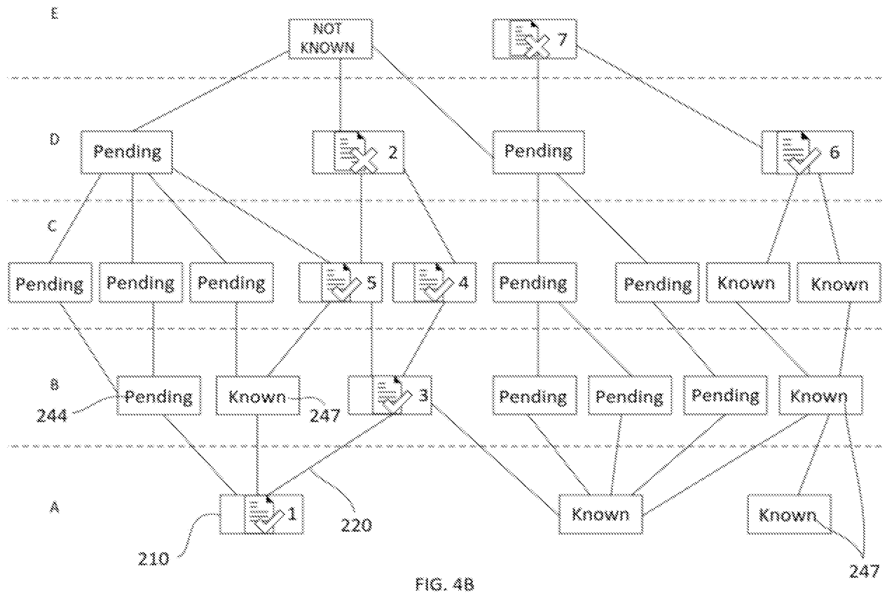

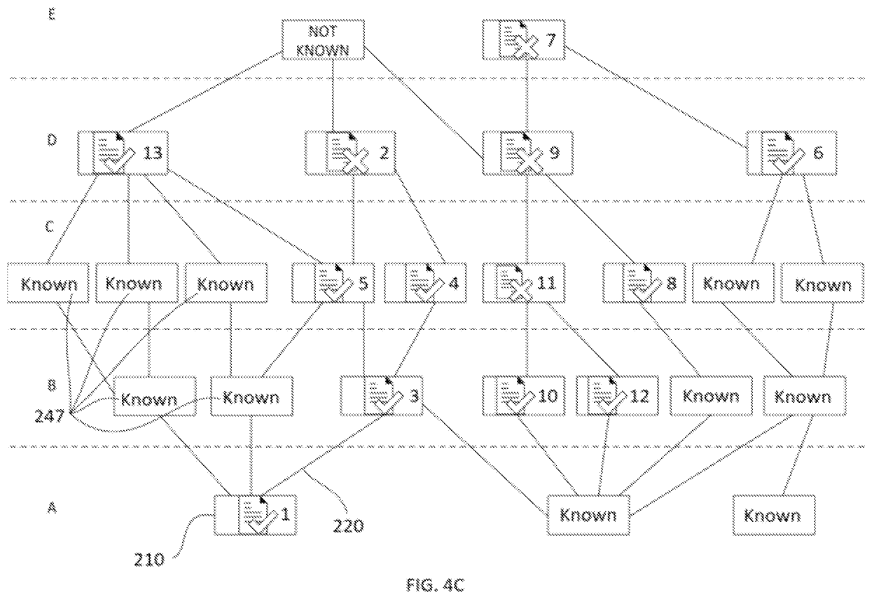

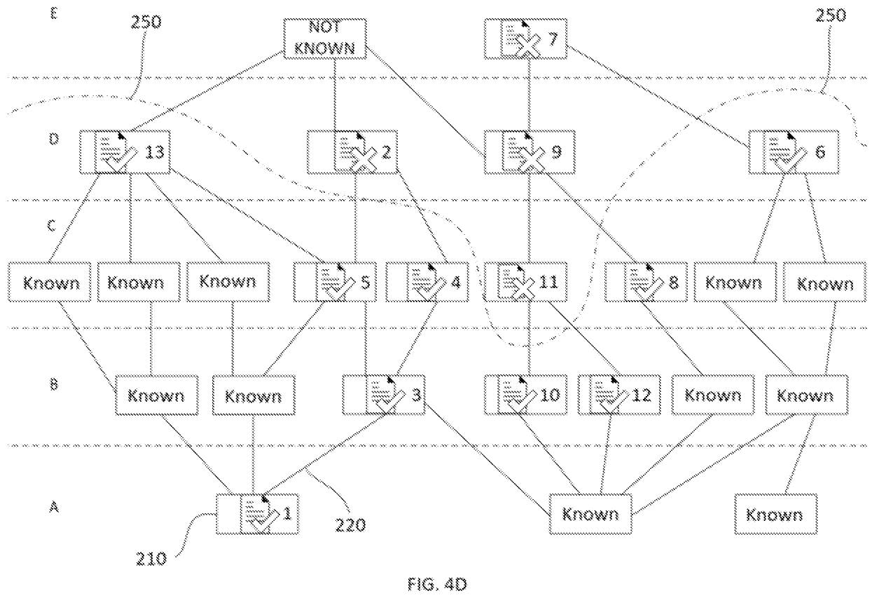

As indicated, the process randomly selects a concept and assesses the individual based on a question or skill assessment associated with that concept. The process continues through the relevant portion (e.g., a substructure corresponding to the desired objective) of the hierarchal data structure by moving the individual up one section/quintile higher each time they have a correct answer or acceptable skill assessment (stopping at the top-most section, of course) and dropping the individual down 2 sections/quintiles (where possible as noted above) when they incorrectly answer a question or fail the skill assessment. This continues with the exceptions where if upon answering a correct question and the section/quintile above within the current branch has no remaining non-assessed concepts or the nodes are marked ‘pending’ then the individual would move horizontally in the section/quintile until finishing that current branch before jumping to another branch. Similarly, if the individual is at the lowest section and misses a question or doesn't pass a skill assessment they would move horizontally in the lowest section within the current branch through any remaining non-assessed or non-determined concepts (determined concepts can be pending, inferred known, tested known, and tested not-known) until moving to a new branch. Once an individual completes the current branch they are in, the system randomly selects a new branch and starts the individual off in the second highest section/quintile of that new branch. Examples of how this navigation works are shown in FIGS. 4A-4D and FIG. 5.

It should be noted that the term non-assessed with respect to a node or concepts where an individual has not yet fielded a question or a skill assessment associated therewith. Some concepts can be determined if based on another depending or underlying concept that is designated as a ‘tested not-known’ or ‘tested known’ where the determination of ‘not known’ or ‘inferred known’ can be made. This will visually become more apparent with respect to FIGS. 4A-4D and FIG. 5, and is in part what enables the navigation of the hierarchal data structure to become more efficient.

Now referring to FIGS. 4A-4C, which illustrate a visual interpretation of an exemplary assessment of an individual navigating a hierarchical knowledge data structure (or some subsection corresponding to a desired objective) using the testing methodology previously described. For this particular example, the individual is directed to begin in the lowest section/quintile A where they are questioned or evaluated based on a randomly selected node representative of a concept belonging to the desired objective. Moving forward the description will focus on knowledge and questions, but it should be readily understood that skill sets, and skill assessments can be used interchangeably. Nodes are marked with ‘pending’ indicator, e.g., node 244, indicating that have not been tested or had inferred information regarding them. Back to FIG. 4A, in this example the individual correctly responds to a question associated with this first selected concept, e.g., node 210, as designated by the numeral 1. For illustration purposes, each node that includes the checkmark designation 240 is meant to indicate a correctly answered question or skill assessment, which was noted above as ‘tested known,’ while the X-mark designation 242 is meant to indicate an incorrectly answered question or ‘tested not-known.’ As result of this correct answer to question 1, the system moves the individual to a second concept within the same branch in section/quintile D per the flowcharts 300A-B, of jumping to the second highest section/quintile, which here is represented by section D, with section E being the highest section/quintile. Continuing the example, the individual incorrectly responds to question 2, so the node associated with question 2 is now marked with an X-mark 242 and the node above it, from which it depends, is now marked ‘not known’ 245 as it cannot be determined or inferred as ‘not-known.’ The system now moves the individual down 2 sections, to section B, where the only available node within the same branch is selected.

Referring to FIG. 4B now, a third question is answered correctly, question 3, so the processing moves up a section/quintile to section C and picks a random concept, of the available two concepts. The individual correctly answers question 4 and, since the section/quintile above has already been assessed as ‘tested not-known,’ the individual moves horizontally to the remaining concept/node available in the current branch.

The individual then correctly answers question 5, so the process marks that node with the check mark designation 240 and marks the remaining pending node that it depends upon with an inferred ‘known’ 247 designation.

In this example, with one branch completed, processing returns to the second highest section/quintile to section/quintile B and randomly selects an assessed branch of the desired objective, and a beginning node within that new branch. Here the individual is now provided question 6. For this example, the individual answers this correctly, so the system can now fill in the underlying nodes with the ‘known’ indicator as the knowledge associated with each of those underlying concepts has been determined as ‘inferred known.’ This inference basically suggests that the individual must understand or know the inferred concepts in order to correctly respond to the assessment of question 6.

Continuing the exemplary assessment into FIG. 4C, the individual is promoted up to concepts in the highest section/quintile E, but assume this time they miss question 7, so they drop down 2 sections again within the current branch. Question 8 is correctly answered, which fills in another node with ‘known’ and the individual jumps up a section/quintile within the current branch. Question 9 in section/quintile D is incorrectly answered, so the individual is dropped down to section B where one of the two remaining non-assessed and non-determined nodes is randomly selected. The individual answers question 10 correctly and is promoted up to section/quintile C within the current branch. Question 11 is incorrectly answered but, since the user has already been assessed on each of the concepts in section E, the first user moves down only one section/quintile to the remaining non-assessed and non-determined node in the current branch. Question 12 is answered correctly and because the branch line has now been fully assessed/determined the process jumps the individual to the second highest section/quintile D and selects the last remaining branch available. Question 13 is answered correctly, so each of the five pending nodes below question 13 are now marked with the inferred ‘known’ indicator. At this point, all of the nodes or concepts have either been directly tested on or as a result of the of the inferred ‘not known’ or inferred ‘known’ determinations are completed, thus the assessment is completed at this point. With the assessment completed, additional information can now be obtained.

FIG. 4D illustrates a visual interpretation of the “Frontal Edge” of the individual's knowledge and skill set within the relevant section of the hierarchical knowledge data structure. In particular, nodes that are above the frontal edge line 250 are all associated with concepts to which the user has incorrectly answered questions or otherwise failed to demonstrate knowledge, or a sufficient skill set for these concepts. This area above frontal edge line 250 can be referred to as the unknown area for the individual, which is contrast with the known area of the individual's knowledge and skill set, i.e., everything below the frontal edge line 250. Each of these nodes have had correct answers associated with them or have been marked inferred ‘known’ or ‘pending’ because of a determination based on the node dependency in the hierarchical data structure, as noted. Obtaining this frontal edge of knowledge analysis accomplishes one of the objectives of the system.

It should be noted that the visual display of the individual's frontal edge, as indicated by frontal edge line 250, of knowledge and skill can be displayed in various forms, including the illustration in FIG. 4D. It is often the case that an individual will have a jagged edge of knowledge and skill, as conveyed by frontal edge line 250. This enables assessed individuals and those performing and reviewing the assessments a much greater granularity of understanding of a particular individual's knowledge base. At this point, it should be readily apparent to those skilled in the art how this could be applied to students, employees, skilled workers, as well as those teaching or supervising them in terms of individualized education plans, individualized training programs, and even utilized to appropriately compensate individuals based at least in part on the assessment. Repeating the above-identified advantage, the navigation methodology described enables an efficient and effective (accurate) assessment. It also eliminates unnecessary time.

Referring now to FIG. 5, this figure illustrates the speed at which a second individual could navigate a desired subsection of a knowledge data structure, contrasted to that of FIG. 4C. In FIG. 5, a second individual starts at same spot as in FIGS. 4A-4C, and because the second individual answers question 1 correctly jumps up to section D within the same branch, just like before. In this illustrative example, the second individual correctly answers question 2, so each of those concepts/nodes upon which question 2 depends can be marked ‘known.’ The process now moves the second individual to Section E where they correctly answer question 3 correctly, which similarly fills in the remaining dependent/requisite nodes as ‘known’, i.e., those nodes upon which question 3 depends. Since there is only one node remaining at this point, there is no random selection of concepts in this section and the second individual is given question 4, associated with the last non-assessed node or determined node, which the second individual, again, answers correctly. Thus, over the course of 4 correctly answered questions the second individual's knowledge is quickly assessed, as shown in FIG. 5. Contrast this with the first individual's knowledge assessment in FIG. 4C, which required the first individual to take 13 total questions to fully assess. Additional analysis and comparisons can now be determined.

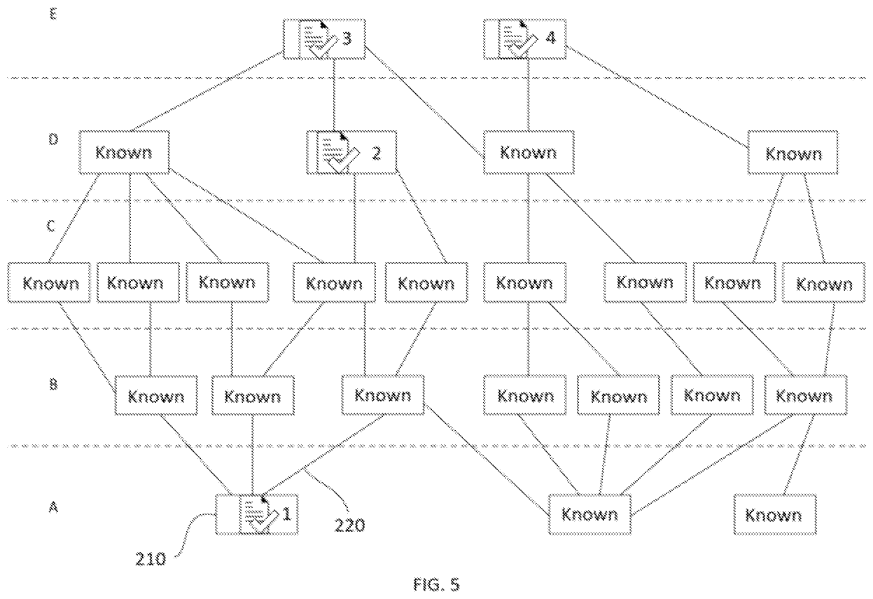

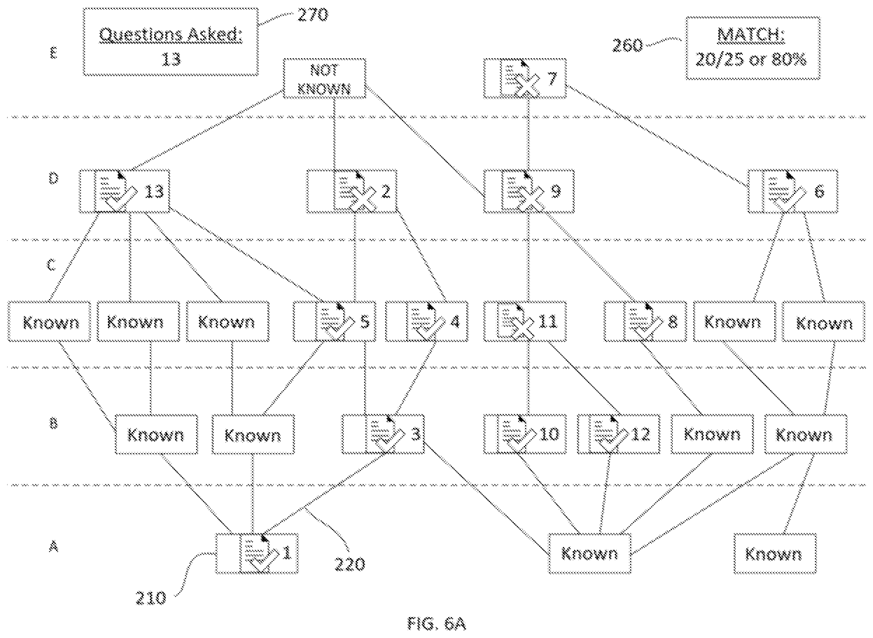

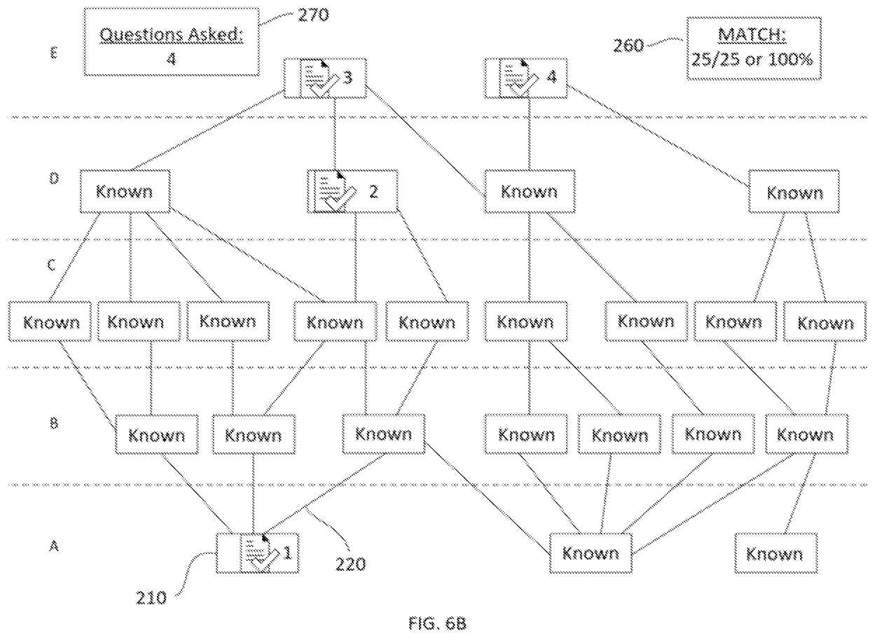

FIGS. 6A and 6B illustrate one embodiment of determining a match scores 260 for an individual upon completing an assessment based on concepts within the hierarchal data structure. FIG. 6A is representative of the path and assessment of the first individual described in conjunction with FIG. 4C, while FIG. 6B is representative of the path and assessment of the second individual described in conjunction with FIG. 5. As previously noted, the first individual of FIG. 4C responded to a total of thirteen (13) questions, as indicated by box 270, out of a possible of 25 total questions. As result of the particular path taken, a match score 260 of 80%, or 20/25 known concepts, is determined. The match score is combination of correctly answered questions 270 and the ‘known’ nodes generated or determined based on the specific questions being correctly answered and node dependency. FIG. 6B is, in contrast to FIG. 6A, indicates that the second individual took and answered correctly four questions, per box 270 of FIG. 6B, which resulted in a match score of 100% or 25/25 known concepts.

From these additional illustrations and comparisons, it is readily understood that this system reduces the amount of time potentially wasted testing individuals, who already obtained a particular knowledge base, while accurately defining a frontal edge of knowledge for others also in an efficient manner. For example, the first individual who took thirteen questions, still saved time by not having to take an additional twelve questions, in order to assess the twenty-five concepts, but it did take the first individual just over three times the number of questions as the second individual.

Once again, this process, or system, could be employed in for example, an elementary school, where one student could get a match score of 80% at a particular math grade level while another could get 100% in less time. At this point, it would be beneficial to test the 100% match student at the next grade level up until that truly defined frontal edge of knowledge is determined. Both students would now benefit as a result of the accurate assessments, while likely minimizing the time required to perform such an assessment.

Knowledge obtained doesn't always stay or remain in long term memory, so the aspects of the disclosed subject matter also may include mechanisms for reinforcing that knowledge to get it into long term memory. FIG. 7 illustrates a flowchart 700 for using a hierarchical knowledge data structure to reinforce knowledge into long term memory. For many reasons, it is important to reinforce obtained knowledge, so as to maintain that knowledge long term. After a random period of time, an individual that has been previously assessed, can be assessed again on the same hierarchal knowledge data structure to update and/or confirm their current frontal edge of knowledge. Similar to the initial setup of 300A and 300B, the re-assessment flowchart 700 can place the individual's starting section/quintile based on their history, which this time includes starting the individual in a section/quintile and on concepts of a section/quintile where the individual previously demonstrated a correct answer or ‘known’ knowledge. Once they are in this second starting section/quintile, the system and method can randomly select a concept to question the individual for assessment. If the individual answers correctly, they continue to move through the hierarchal knowledge data structure like before, by moving up a section/quintile when responding to a question correctly and down 2 sections (if possible) when answering a question incorrectly. However, if the individual starts out with an incorrect question, the system can provide a lesson on the missed concept prior to finishing the re-assessment. The provision of a lesson's purpose in to solidify the knowledge into long-term memory. Providing lessons on subjects has been shown to be effective of retaining knowledge in long-term memory, especially where an individual misses something they previously knew and are quickly provided a refresher demonstration or lesson on that particular concept. Once the individual has completed this lesson, they can continue to navigate the hierarchal knowledge data structure like before: up one section with a correct response or down two sections with an incorrect response. The system can also be configured to provide additional lessons for any additional missed concepts that were previously answered correctly or ‘known.’ Once the assessment is finished, an updated frontal edge of knowledge for that individual can be provided.

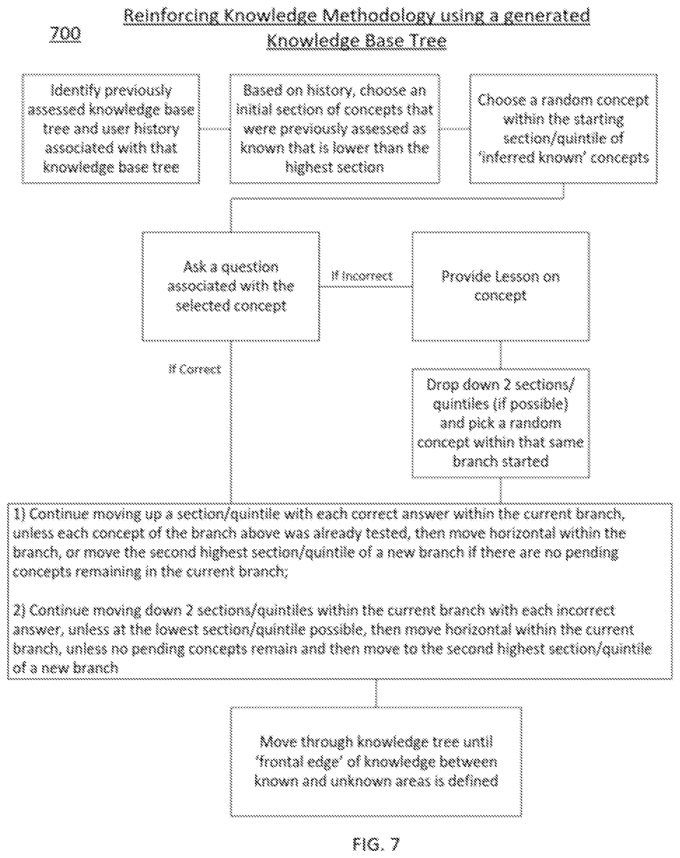

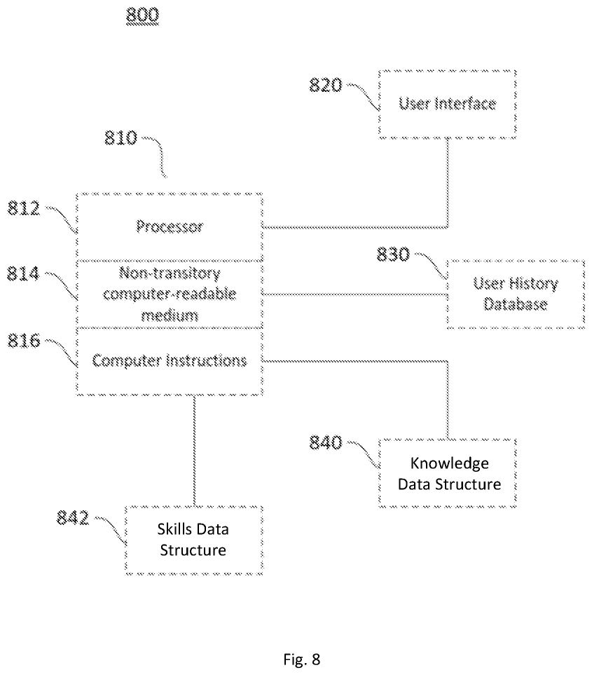

FIG. 8 illustrates a basic computing system 800 that can operate the methods and processes described above. It will be understood that the methods and processes discussed herein can be performed by a computing system 800 or be installed as a local program or plug-ins on a local computer 810 that include processor(s) 812, non-transitory computer-readable medium(s) 814, that can include instructions 816 to perform all or some of the tasks and processes discussed herein. The computer 810 can be connected to a user interface 820, which can be a separate computing device, or a keyboard, mouse and monitor directly connected to 810. The computer 810 can be networked to a user history database 830, a knowledge data structure 840 which may or may not include a skills data structure 842. The user interface 820 can receive the inputs from a user/individual, which in turn can process the process and use appropriate databases and structures, including but not limited to a hierarchical knowledge data structure, as noted above.

As may be appreciated by those skilled in the art, a desired objective may encompass multiple concepts. However, for any given objective, the encompassed concepts are likely not equal in importance to the objective. For example, for an objective that encompasses the concepts of basic mathematics and shipping logistics, knowledge of or skill in basic mathematics concept, while important, may be far less important than knowledge of shipping and export regulations. Thus, when assessing the knowledge and/or skill set of an individual for a desire objective the encompasses multiple concepts, it is often very important, perhaps even necessary, to be able to differentiate the scores with respect to the various concepts.

According to aspects of the disclosed subject matter, rather than determining a single match score, as described with respect to FIGS. 6A and 6B, when generating the results of an assessment, an improved result is the output of a multi-dimensional vector, where each dimension corresponds to a concept score of the desired objective.

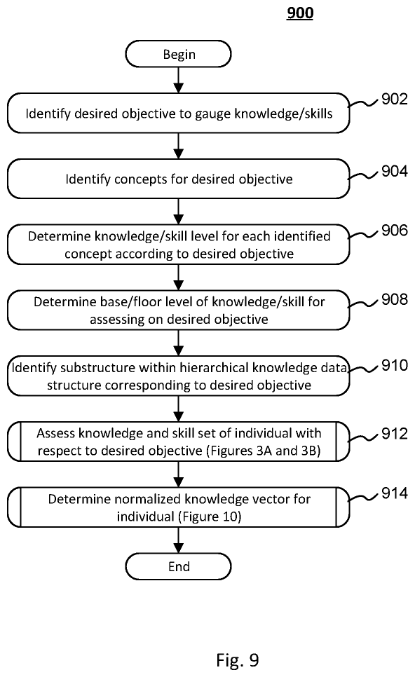

Indeed, the multi-dimensional vector from the assessment, referred to as a raw knowledge vector, simply has a “concept score” that indicates a knowledge or skill level relative to the desired level of knowledge or skill for the concept. In some embodiments, this concept score may be based on a percentage of correct responses. However, a simple percentage may not accurately reflect the knowledge of a person for a variety of reasons including, by way of illustration and not limitation, the number of assessment questions regarding the concept may be small or insignificant, the knowledge gap between one assessment question and a higher (or lower) assessment question may be large such that a simple percentage of questions fails to accurately reflect the knowledge of the individual with that concept. Accordingly, and as will be presented below, additional processing to determine an accurate assessment of knowledge for any given concept (relative to the desired object) is often needed. According to aspects of the disclosed subject matter, a multi-dimensional knowledge vector may comprise 3 or more dimensions (corresponding to three or more concepts of a desired objective.) To illustrate this enhanced scoring using multi-dimensional knowledge vectors, reference is now made to FIG. 9.

As suggested, FIG. 9 illustrates a method 900 of assessing an individual's knowledge and/or skill set with respect to a desired objective, in accordance with aspects of the disclosed subject matter. Beginning at block 902, a desired objective is identified for assessing one or more individuals' knowledge or skill set. At block 904, a plurality of concepts encompassed in the desired object are identified. While not shown, if a knowledge data structure data, which includes the identified concepts to the level of the desired objective, is not available, this data structure is generated from knowledge and skill set databases.

At block 906, the top level of knowledge and/or skill of each concept in the desired objective is determined. Similarly, at block 908, a bottom or floor level of acceptable knowledge and skill is identified for each concept. Based on the upper and lower levels of each concept, a substructure of a knowledge data structure is identified. Of course, it should be appreciated that in various embodiments, an actual, at least temporary, substructure may be generated for use in evaluation. Generating the substructure may be useful for sectioning the substructure into quintiles (or some other number of segments) but, those skilled in the art will appreciate that it would not be mandatory as such sectioning may be made virtually to a knowledge data structure using pointers or references.

At block 910, one or more individuals may be assessed as to their knowledge and skill sets relative to the desired objective. For simplicity, routine 900 indicates that a single individual's knowledge and skill is assessed, relative to the desired objective. As described earlier with respect to FIGS. 3A and 3B, and according to aspects of the disclosed subject matter, the substructure (corresponding to the desired objective) is sectioned into quintiles or some other number of sections. For description purposes, the fifth quintile will be the highest quintile and includes the knowledge levels of the multiple concepts equaling the desired objective. Additionally, and according to aspects of the disclosed subject matter, unless there is reason to believe that the to-be-assessed individual should begin in a lower quintile (i.e., he/she has previously assessed lower with respect to this desired objective), the individual begins assessment in the fourth quartile.

As suggested and according to aspects of the disclosed subject matter, correctly responding to a question or task causes the process to advance the individual to questions in the next higher quartile (with respect to the current topic being assess with the question), while an incorrect response to a question or task causes the process to lower the individual to questions in a quartile two levels lower than the current quartile. Of course, if the individual is already in the second-to last quartile, the individual is lowered only one quartile, and if the individual is already in the lowest quartile, no other lowering takes place but other questions in that lowest quartile may be posed to the individual to identify the extent of the knowledge and skill of the individual.

Advantageously, beginning an assessment of an individual in the fourth quartile maximizes the efficiency in identifying/assessing the individual's frontal level of knowledge and skill. Indeed, advancing up one level or down two levels based on first assessment question (per topic) enables the process to identify a general area (quintile) of knowledge and skill without wading forcing the individual up-through all of the questions beginning at the bottom. Indeed, by inferring as much knowledge as possible, the amount of time each individual is engaged in the assessment is minimized. This also reduces fatigue of the individual, reducing the likelihood of fatigue playing a role in responding incorrectly to a question.

The result of the assessment of block 912 is to obtain a raw knowledge vector, where each element of the vector is a score reflecting the highest position within the substructure for the corresponding topic that the individual responded correctly. These scores are considered “raw” as they have not been processed or normalized in order to be valuable in determining the frontal knowledge of the individual relative to the desired objective. Accordingly, at block 914, the raw knowledge vector is processed, thereby generating a normalized, multi-dimensional knowledge vector as well as a value representing a scaled position of the individual's knowledge relative to the desired objective. Thereafter, the routine 900 terminates.

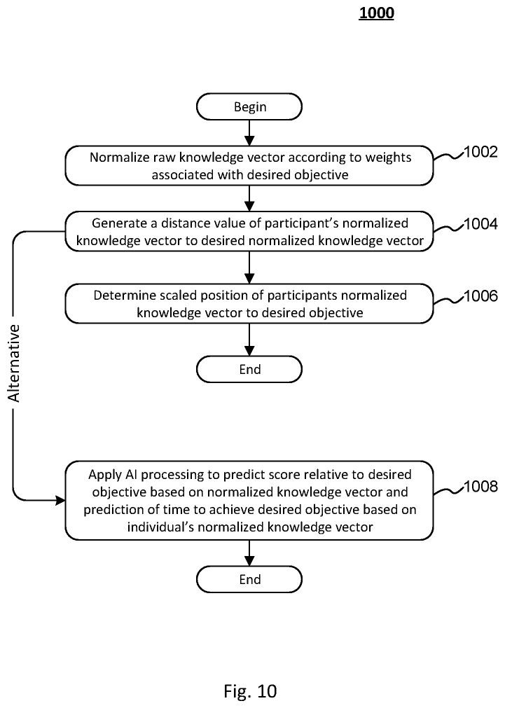

Processing a raw knowledge vector is described in greater detail with respect to routine 1000 of FIG. 10. Indeed, FIG. 10 illustrates method 1000 for quantifying an individual's frontal knowledge, represented as a raw knowledge vector, into a scaled, normalized multi-dimensional vector, in accordance with aspects of the disclosed subject matter. Beginning at block 1002, the raw knowledge vector is normalized according to weights and scales applicable to the various dimensions/topics of the vector. Indeed, this normalizing and scaling reflects any number of features and putting this value into a predefined range, e.g., from 0.0 to 1.0 (where 1.0 represents the highest level of knowledge desired for the topic). Normalizing or weighting notably includes reflecting the importance (or lack of importance) of a given dimension/topic to the desired objective.

At block 1004, a distance value is determined between the normalized knowledge vector is determined. As will be readily appreciated by those skilled in the art, determining a distance value between two points in a multi-dimensional space (the two points being the normalizes knowledge vector and a similarly normalized vector reflecting the highest desired levels of each topic of the desired objective) involves a computer-implemented evaluation that determines dot-product values between the two as they are projected into the multi-dimensional space.

At block 1006, the distance value can be scaled to a predetermined range e.g., from 0.0 to 1.0 (where 1.0 represents an exact match to the desired objective.) Scaling is typically done at this point according to predetermined heuristics. Alternatively, rather than utilizing predetermined heuristics, and as shown in block 1008, artificial intelligence, e.g., a trained machine learning model, may be utilized to generate a predictive, likely score reflecting the knowledge of the individual as reflected in the normalized knowledge vector relative to the highest level of knowledge as set forth in the desired objective. This AI processing may further consider elements such as likely time for the individual to acquire the desired objective (given training to do so) based on the performance of others.

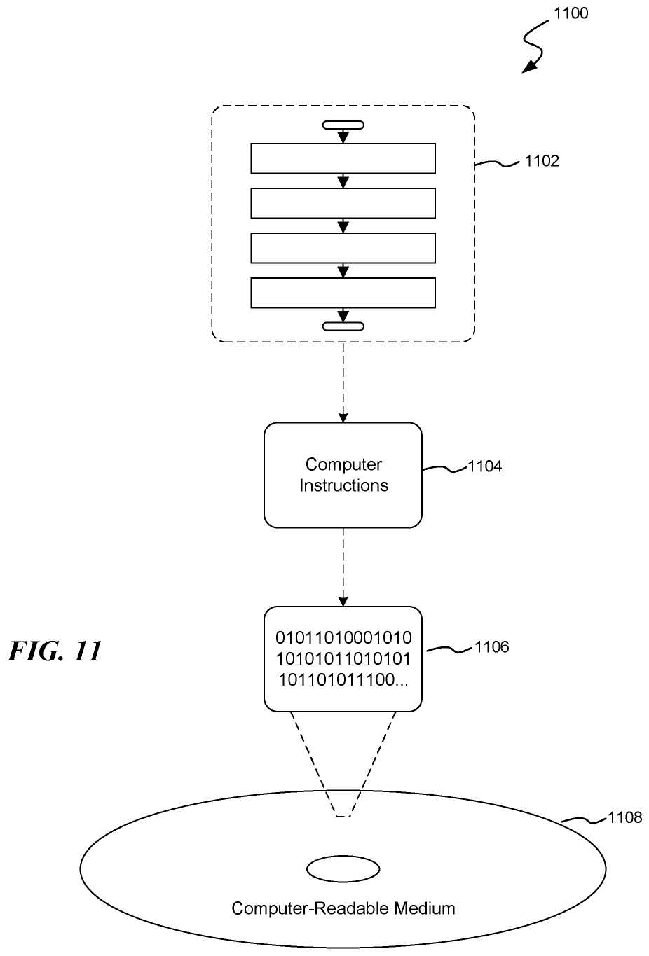

Turning now to FIG. 11, this figure illustrates a logical organization 1100 of computer-readable media bearing executable components that, when executed on a computer system, implement a knowledge and skills assessment system and/or method in accordance with aspects of the disclosed subject matter. As will be appreciated by those skilled in the art, the logical organization comprises computer-readable medium 1108 (e.g., a CD-R, DVD-R or a platter of a hard disk drive), on which is encoded computer-readable data 1106. Non-limiting examples of a computer-readable medium (or media) include optical media (e.g., compact discs, “CDs”, in various writable and/or non-writable forms, digital versatile discs, “DVDs” in their various writeable and/or non-writable forms, etc.), solid-state memory devices (e.g., USB “thumb” drives, flash memory cards or devices, etc.), magnetic discs and tapes, read-only cartridge devices, hard drives, and the like.

This computer-readable data 1106 in turn comprises a set of computer-executable instructions 1104 that, when executed by a processor of a computer, operate according to one or more of the embodiments of a multi-view framework (MVF) set forth herein. In one such embodiment, the computer-executable instructions 1104 may be configured to perform one or more methods and/or routines, such as the exemplary discussed above, for example and without limitation. In another such embodiment, the computer-executable instructions 1104 may be configured to implement logical elements of a computing system, such as at least some of the exemplary computing system 800, as described below. The logical steps and/or computer-executable instructions are indicated by the logical elements 1102.

While the foregoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention.

1. An computer-implemented assessment generator and updating assessment method with respect to the knowledge and skill set of a participant, comprising:
receiving a desired objective via a user interface of a computer system, the desired objective corresponding to knowledge and/or skill set of a plurality of concepts;
determining a desired objective knowledge and skill set level within a hierarchical knowledge data structure for each of the plurality of concepts that corresponds to and fully meets the desired objective;
determining a base knowledge and skill set level within the knowledge data structure for each of the plurality of concepts, the base knowledge and skill set level being a lowest limit of knowledge and skill set to be assessed within the knowledge data structure;
determining a substructure of the knowledge data structure from the desired objective knowledge and skill set level to the base knowledge and skill set level;
parsing the substructure into a plurality of sections, wherein the concept items in each section are connected to one or more concept items in another section above or below, and wherein concept item is associated with a question or skill test;
processing each concept of the plurality of concepts, wherein processing a current concept of the plurality of concepts comprises:
selecting a first section of the current concept as the current section of the current concept and a first concept item in the current section as a current concept item;
repeatedly:
assessing the participant with respect to the question associated with the current concept item;
upon a correct response to the question associated with the current concept item, selecting a section one position above the current section of the current concept as the current section for the current concept when at least one section above the current section of the current concept exists, and selecting an unassessed concept item in the current section as the current concept item in the current section;
upon an incorrect response to the question associated with the current concept item, selecting a section two below the current section of the current concept as the current section for the current concept when at least two sections below the current section of the current concept exist, or selecting a section one below the current section of the current concept as the current section for the current concept when only one section below the current section exists, and selecting an unassessed concept item in the current section as the current concept item in the current section;
until a concept item of the current concept is identified as the front edge of knowledge of the participant for the current concept;
updating an element of an element corresponding to the current concept of the knowledge vector with a score corresponding to the highest concept item for the current concept identified as being correctly assessed; and
selecting an unprocessed concept of the plurality of concepts as the current concept until all concepts of the plurality of concepts are processed; and
providing the multi-dimensional knowledge vector as the frontal knowledge of the participant.

2. The computer-implemented assessment generator and updating assessment method of claim 1, further comprising normalizing the multi-dimensional knowledge vector according to a set of predetermined weighting factors to produce a normalized knowledge vector.

3. The computer-implemented assessment generator and updating assessment method of claim 2, further comprising:
projecting the normalized knowledge vector into a multi-dimensional space;
projecting a knowledge vector corresponding to the desired objective into the multi-dimensional space;
determining a distance measure between the projected normalized knowledge vector and the projected knowledge vector corresponding to the desired objective; and
scaling the distance to a first scale to as on overall score for the participant.

4. The computer-implemented assessment generator and updating assessment method of claim 1, wherein the substructure is parsed into quintiles.

5. The computer-implemented assessment generator and updating assessment method of claim 4, wherein the first section for each of the plurality of concepts selected as a current section is the fourth highest quintile.

6. A computer system configured to assess the knowledge and skill of a participant with respect to a desired objective, the computer system comprising a processor and a memory, and wherein the computer system, in operation, is configured to:
receive a desired objective via a user interface of the computer system, the desired objective corresponding to knowledge and/or skill set of a plurality of concepts;
determine a desired objective knowledge and skill set level within a hierarchical knowledge data structure for each of the plurality of concepts that corresponds to and fully meets the desired objective;
determine a base knowledge and skill set level within the knowledge data structure for each of the plurality of concepts, the base knowledge and skill set level being a lowest limit of knowledge and skill set to be assessed within the knowledge data structure;
determine a substructure of the knowledge data structure from the desired objective knowledge and skill set level to the base knowledge and skill set level;
parse the substructure into a plurality of sections, wherein the concept items in each section are connected to one or more concept items in another section above or below, and wherein concept item is associated with a question or skill test;
process each concept of the plurality of concepts, wherein processing a current concept of the plurality of concepts comprises:
select a first section of the current concept as the current section of the current concept and a first concept item in the current section as a current concept item;
repeatedly:
assess the participant with respect to the question associated with the current concept item;
upon a correct response to the question associated with the current concept item, selecting a section one position above the current section of the current concept as the current section for the current concept when at least one section above the current section of the current concept exists, and selecting an unassessed concept item in the current section as the current concept item in the current section;
upon an incorrect response to the question associated with the current concept item, select a section two below the current section of the current concept as the current section for the current concept when at least two sections below the current section of the current concept exist, or select a section one below the current section of the current concept as the current section for the current concept when only one section below the current section exists, and select an unassessed concept item in the current section as the current concept item in the current section;
until a concept item of the current concept is identified as the front edge of knowledge of the participant for the current concept;
update an element of an element corresponding to the current concept of the knowledge vector with a score corresponding to the highest concept item for the current concept identified as being correctly assessed; and
select an unprocessed concept of the plurality of concepts as the current concept until all concepts of the plurality of concepts are processed; and
provide the multi-dimensional knowledge vector as the frontal knowledge of the participant.

7. The computer system of claim 6, wherein the computer system is further configured to normalize the multi-dimensional knowledge vector according to a set of predetermined weighting factors to produce a normalized knowledge vector.

8. The computer system of claim 7, wherein the computer system is further configured to:
project the normalized knowledge vector into a multi-dimensional space;
project a knowledge vector corresponding to the desired objective into the multi-dimensional space;
determine a distance measure between the projected normalized knowledge vector and the projected knowledge vector corresponding to the desired objective; and
scale the distance to a first scale to as on overall score for the participant.

9. The computer system of claim 6, wherein the substructure is parsed into quintiles.

10. The computer system of claim 6, wherein the first section for each of the plurality of concepts selected as a current section is the fourth highest quintile.

11. A computer-readable medium bearing computer-executable instructions which, when executed by a processor of a computer system, carry out a method for assessing the knowledge and skill set of a participant with respect to a desired objective, the method comprising:
receiving a desired objective via a user interface of a computer system, the desired objective corresponding to knowledge and/or skill set of a plurality of concepts;
determining a desired objective knowledge and skill set level within a hierarchical knowledge data structure for each of the plurality of concepts that corresponds to and fully meets the desired objective;
determining a base knowledge and skill set level within the knowledge data structure for each of the plurality of concepts, the base knowledge and skill set level being a lowest limit of knowledge and skill set to be assessed within the knowledge data structure;
determining a substructure of the knowledge data structure from the desired objective knowledge and skill set level to the base knowledge and skill set level;
parsing the substructure into a plurality of sections, wherein the concept items in each section are connected to one or more concept items in another section above or below, and wherein concept item is associated with a question or skill test;
processing each concept of the plurality of concepts, wherein processing a current concept of the plurality of concepts comprises:
selecting a first section of the current concept as the current section of the current concept and a first concept item in the current section as a current concept item;
repeatedly:
assessing the participant with respect to the question associated with the current concept item;
upon a correct response to the question associated with the current concept item, selecting a section one position above the current section of the current concept as the current section for the current concept when at least one section above the current section of the current concept exists, and selecting an unassessed concept item in the current section as the current concept item in the current section;
upon an incorrect response to the question associated with the current concept item, selecting a section two below the current section of the current concept as the current section for the current concept when at least two sections below the current section of the current concept exist, or selecting a section one below the current section of the current concept as the current section for the current concept when only one section below the current section exists, and selecting an unassessed concept item in the current section as the current concept item in the current section;
until a concept item of the current concept is identified as the front edge of knowledge of the participant for the current concept;
updating an element of an element corresponding to the current concept of the knowledge vector with a score corresponding to the highest concept item for the current concept identified as being correctly assessed; and
selecting an unprocessed concept of the plurality of concepts as the current concept until all concepts of the plurality of concepts are processed; and
providing the multi-dimensional knowledge vector as the frontal knowledge of the participant.

12. The computer-readable medium of claim 11, wherein the method further comprises normalizing the multi-dimensional knowledge vector according to a set of predetermined weighting factors to produce a normalized knowledge vector.

13. The computer-readable medium of claim 12, wherein the method further comprises:
projecting the normalized knowledge vector into a multi-dimensional space;
projecting a knowledge vector corresponding to the desired objective into the multi-dimensional space;
determining a distance measure between the projected normalized knowledge vector and the projected knowledge vector corresponding to the desired objective; and
scaling the distance to a first scale to as on overall score for the participant.

14. The computer-readable medium of claim 11, wherein the substructure is parsed into quintiles.

15. The computer-readable medium of claim 14, wherein the first section for each of the plurality of concepts selected as a current section is the fourth highest quintile.
